(19) United States
(12) Patent Application Publication
(10) Pub. No.: US 2024/0017466 A1
(43) Pub. Date: Jan. 18, 2024

(54) APPARATUS AND METHOD FOR FORMING PLASTIC PREFORMS INTO PLASTIC CONTAINERS WITH CHANGEOVER ROBOT

(71) Applicant: KRONES AG, Neutraubling (DE)

(72) Inventors: Martin SCHLAGENHAUFER, Regensburg (DE); Florian GELTINGER, Donaustauf (DE)

(21) Appl. No.: 18/222,922

(22) Filed: Jul. 17, 2023

(30) Foreign Application Priority Data
Jul. 15, 2022 (DE) 10 2022 117 742.4

(51) Int. Cl. B29C 49/36; B29C 49/42; B29C 49/46

(52) U.S. Cl. CPC B29C 49/36; B29C 49/42073; B29C 49/46; B29C 2049/4697

(57) ABSTRACT

Apparatus for forming plastic preforms into plastic containers has a transport device having a rotatable transport carrier on which a large number of forming stations are arranged. The forming stations each have blow molding devices, within which the plastic preforms can be formed into the plastic containers by applying a flowable medium, and the forming stations each have application devices for applying the flowable medium to the plastic preforms. The apparatus has a clean room within which the plastic preforms are expanded to form the plastic containers, and such clean room is delimited from a non-sterile environment by at least one wall. The apparatus also has an exchange device for exchanging blow molding devices.

### BACKGROUND OF THE INVENTION

The present document relates to an apparatus and a method for forming plastic preforms into plastic containers. Such apparatuses and methods have long been known from the prior art. Usually, heated plastic preforms are formed into plastic containers by means of applying a flowable medium, in particular compressed air. More recently, however, it has also been known to use a liquid, such as in particular but not exclusively the beverage to be filled, to expand the plastic preforms.

More recently, sterile apparatuses of this type have also become known to some extent. These have the advantage that plastic preforms can either already come directly from a furnace and are therefore sterile or have been sterilized by a sterilization device. Subsequently, they can be formed into the plastic containers in the same sterile manner. Such apparatuses typically have clean rooms within which the expansion process takes place.

In the prior art, it has been shown that keeping the clean room sterile, or sterilizing it, is relatively costly. This arises in part as a result of extensive interaction between the user and the system. From time to time, blow molding devices in such apparatuses have to be replaced, for example in order to be able to switch to different bottles. In the prior art, this usually requires extensive user intervention.

The present invention is therefore based on the object of making such blow molding machines more reliable in operation. This is achieved according to the invention by the subject matter of the independent claims. Advantageous embodiments and developments are the subject matter of the dependent claims.

### SUMMARY OF THE INVENTION

An apparatus according to the invention for forming plastic preforms into plastic containers has a transport device, which transports the plastic preforms to be formed along a predefined transport path. In this case, the transport device has a rotatable transport carrier on which a large number of forming stations is arranged, wherein such forming stations each have blow molding devices, within which the plastic preforms can be formed, and in particular expanded, into the plastic containers by applying a flowable and, in particular, gaseous medium.

Furthermore, the forming stations each have application devices for applying the flowable medium to the plastic preforms, wherein the apparatus furthermore has a clean room within which the plastic preforms are expanded or expandable into the plastic containers. Furthermore, such clean room is delimited from a non-sterile environment by means of at least one wall.

According to the invention, the apparatus has an exchange device for exchanging blow molding devices. Preferably, such exchange device enables automatic or automated exchange of the blow molds. Preferably, the exchange device is arranged outside the clean room.

It is therefore proposed within the scope of the invention to equip such a (sterile) blow molding machine with an exchange device and, in particular, an exchange robot. In this manner, more precisely defined exchange processes can be carried out and there are precisely defined interactions between the exchange device and the actual blow molding machine. In this manner, the degree of contamination during the exchange process can be significantly reduced.

Preferably, the exchange device is an exchange robot. Particularly preferably, the exchange device has at least one gripping element for gripping the blow molds or blow molding parts. Preferably, the gripping element is movable with respect to at least three, preferably with respect to at least four and particularly preferably with respect to at least five and particularly preferably with respect to at least 6 axes.

In a preferred embodiment, the exchange device has a plurality of, in particular exchangeable, gripping elements for gripping other elements of the blow molding machine, for example for gripping blow nozzles or stretching bars.

Preferably, the exchange device is used to remove the blow molds from the station only as a whole and to deposit them preferably in a magazine device. Thereafter, the exchange device preferably inserts a new set of blow molds.

Particularly preferably, the gripping device is suitable and intended for gripping the blow mold in its entirety. This is another way to simplify the actual exchange process. Preferably, the blow molds have at least two and preferably at least three parts. This can, for example, be two side parts of the blow mold along with a bottom part. Particularly preferably provided are securing means that enable the removal of a complete blow mold and/or that hold the individual parts of the blow molding device together during removal.

Particularly preferably, the blow molding parts are arranged on blow mold carriers. Such blow mold carriers can preferably be pivoted with respect to one another about a shaft in order to open and close the blow mold in a working operation and in an exchange operation.

Particularly preferably, the exchange device is suitable and intended to open and/or close a locking mechanism that holds the blow molding parts or the blow mold carriers together.

In a preferred embodiment, the clean room has an annular and, in particular, toroidal shape. Preferably, the geometric shape of the clean room results from a rotation of a square or polygon about an axis of rotation and, in particular, the axis of rotation with respect to which the transport carrier is rotatable.

Particularly preferably, the apparatus has at least one wall that bounds the clean room with respect to a non-sterile environment. Particularly preferably, the apparatus has at least two walls, wherein one wall is movable and, in particular, rotatable with respect to the other wall.

In a further advantageous embodiment, the apparatus has a circumferential seal. This seal is preferably a hydraulic seal. Particularly preferably, the sealing device has a channel that can be filled or is filled with liquid and, in particular, water. Particularly preferably, the sealing device has a circumferential wall and, in particular, a circumferential blade that dips into said channel. In this respect, the rotational movement of such circumferential wall is coupled in particular to the rotational movement of the rotatable carrier. Particularly preferably, the rotatable wall is arranged on the transport carrier described above.

In particular, the channel that can be filled with the liquid is arranged in a stationary manner.

Particularly preferably, the forming stations each have stretching units that are suitable and intended for stretching the plastic preforms in their longitudinal direction during their expansion. Such stretching units preferably have stretching bars that can be inserted into the interior of the plastic preforms.

In a preferred embodiment, the application device has a blow nozzle that can be applied to a mouth of the plastic preforms in order to expand them. In addition, a sealing against a support ring of the plastic preform and/or against a blow mold would also be conceivable.

Particularly preferably, the exchange device is also suitable and intended for exchanging such blow nozzle. Particularly preferably, the exchange device is also suitable and intended for exchanging a stretching bar.

Preferably, each forming station has a valve arrangement in order to apply different pressure levels to the plastic preforms.

In a preferred embodiment, the apparatus has a drive device for moving the blow nozzle in the longitudinal direction of the containers and, in particular, for advancing it toward the plastic preforms. Such drive device can, for example, be a pneumatic, a hydraulic or an electric drive device.

In a preferred embodiment, the exchange device is arranged at least partially and preferably completely outside the clean room. In this manner, the apparatus can be made smaller in its entirety and there are not too many complicated components inside the clean room. Preferably, the exchange device is arranged completely outside the clean room during a working operation of the apparatus. Preferably, during exchange operation, at least components of the exchange device can be moved through clean room boundaries existing during working operation.

In the prior art, it is sometimes provided that a machine guard opens automatically by means of a machine guard roller blind. In such a case, there is no intervention in an aseptic environment. However, the complete sealing of a clean room or of an isolator interior is not possible in this manner.

In a further advantageous embodiment, the changeover device is suitable and intended for opening the clean room or its housing or a wall that bounds the clean room.

In a preferred embodiment, the apparatus has an actuating device for carrying out a exchange process of blow molding devices of the forming station, wherein, preferably, such actuating device is selected from a group of actuating devices comprising actuating devices for opening and closing blow mold carriers, actuating devices for releasing and/or activating a fastening device for releasing and/or fastening blow molding parts to blow mold carrier parts, actuating devices for centering the rotatable transport carrier, actuating devices for unlocking and/or locking blow mold carriers, actuating devices for tensioning and/or relaxing application devices, actuating devices for opening and/or closing the clean room, and the like.

Particularly preferably, at least one of such actuating units or actuating devices and, in particular, the actuating device for the mold carriers, for a blowing wheel centering device or for the application device and, in particular, for the blow nozzle (in particular in a working operation of the apparatus) is not arranged in the aseptic region and/or the clean room.

An actuating device for opening a lock of the clean room or an opening mechanism in the aseptic region or within the clean room is particularly preferred. Particularly preferably, however, a control for such actuating device is not arranged in the aseptic region and/or within the clean room.

Preferably, at least one of the aforementioned actuating devices, and preferably a plurality of the actuating devices, is therefore arranged outside the clean room. In particular, such actuating devices are part of the exchange device. It is thus possible that the exchange device can accommodate different actuating devices. Particularly preferably, at least one of the actuating devices, and preferably a plurality of the actuating devices, is arranged outside the clean room during a working operation of the apparatus.

In a further advantageous embodiment, the apparatus has a sterilization device for sterilizing the clean room. In particular, the latter can apply a sterilization medium, in particular a flowable sterilization medium, such as peracetic acid or hydrogen peroxide, to the walls of the clean room or the interior of the clean room.

In a preferred embodiment, a sterilization device is also suitable and intended for sterilizing one or more actuating devices.

Particularly preferably, the sterilization device enables CIP (cleaning in place) cleaning of the apparatus or SIP (sterilization in place) sterilization. For this purpose, it is possible that a large number of application devices, such as spray nozzles or spray heads, are arranged inside the room and serve for sterilizing the clean room with a sterilization medium.

In a further preferred embodiment, the sterilization device is suitable for sterilizing blow molding devices.

In a further preferred embodiment, the apparatus has at least one magazine device for storing exchangeable parts of the apparatus and, in particular, for storing blow molding devices and/or blow molding parts. Furthermore, it would be possible for a plurality of magazine devices to be provided, for example for storing blow nozzles, stretching bars or other components.

In a further advantageous embodiment, the apparatus has a housing and/or an enclosure device for enclosing the exchange device. In this manner, a protective region can also be created, which prevents injuries to users but also damage to other machine parts. In a further advantageous embodiment, the apparatus has a detection device that detects an opening of the enclosure.

Particularly preferably, such enclosure is divided into at least two regions and preferably into exactly two regions. Such regions can be arranged next to one another, for example.

Particularly preferably, the exchange device is arranged in one of the two regions and the aforementioned magazine device is arranged in the other region.

Preferably, such two regions are delimited from one another by a securing device and, in particular, a securing device that is suitable and intended to detect whether a user passes from the first region to the second region. Preferably, however, such securing device is designed without a mechanical barrier, for example in the form of a light barrier curtain.

Particularly preferably, the aforementioned magazine device or a plurality of magazine devices is also arranged within such enclosure device. Particularly preferably, the magazine devices are arranged in such a manner that they can also be reached by the exchange device. In a preferred embodiment, the enclosure is designed as a cage and thus enables observation of the processes taking place inside the enclosure.

In a further advantageous embodiment, the apparatus has an openable interface, via which the exchange device can carry out exchange processes. By providing such interface, very defined exchange processes can be carried out.

Particularly preferably, the exchange processes can be carried out through such interface. For example, the clean room can be closed off by a housing with a sliding door and such sliding door can be opened and/or closed, in particular by the exchange device. In addition, the interface can have a locking flap or the like, which can particularly preferably be opened and/or closed by the exchange device. This is another way to avoid further user interaction with the clean room.

In a further advantageous embodiment, the apparatus has an actuating device for opening such interface. Preferably, such actuating device is arranged at least partially and preferably completely inside the clean room.

This can, for example, be a pneumatic, an electric or another activator. This can be arranged on a base plate of the isolator, for example. In a preferred embodiment, such actuating device for opening the interface has a cylinder device and, in particular, a double cylinder. Particularly preferably, a control device for such actuating device is arranged outside the clean room.

In a preferred embodiment, the interface has a separating element that separates the clean room from the environment, wherein such separating element preferably extends in a plane that is oblique with respect to a vertical direction. This design allows the exchange device to bring a robot closer to the blow molding device, for example.

Such separating element can, for example, be a (movable) wall or a (movable) disk or the like. The interface or any window to the isolator region is therefore preferably obliquely arranged in order to be able to place the exchange device or robot as close as possible to the blowing device and/or the individual forming devices and, preferably, also to improve accessibility for the operator.

Particularly preferably, such separating element is inclined by more than 1°, preferably by more than 2°, preferably by more than 3° with respect to a vertical plane. Preferably, the separating element is inclined by less than 20°, preferably by less than 15°, preferably by less than 10° with respect to a vertical plane.

Particularly preferably, the apparatus has a detection device that detects an intervention of a user in predetermined regions of an enclosure for enclosing the exchange device, and preferably a control device, which controls the exchange device taking into account a value detected by such detection device, is provided.

Typically, test runs of the exchange device are provided at the beginning of the work process or after the enclosure has been opened, in order to check whether, for example, blow molding devices have been removed manually from the magazine device. Such detection device makes it possible to ensure that, if it is determined that no user intervention has taken place, a corresponding test run is also omitted, which also facilitates the changeover of blow molds and results in shorter times during which the clean room is open.

Preferably, the detection device is also suitable and intended to detect an intervention of the user in a magazine region. In such design, it is possible to determine that a user has opened the enclosure of the exchange device but has not been active in the region of the magazine device. In this case as well, the aforementioned test run of the exchange device can be dispensed with. For example, it is thus possible that no test run or query round is undertaken if only one door of the enclosure has been made for assembly activities but not for interventions in the magazine device. Such approach can be useful both for an aseptic apparatus described herein and for non-aseptic apparatuses.

For example, it is conceivable that no test run is necessary if, for example, either a main entrance door, such as a swing door of the enclosure region, has been opened and/or a magazine query has not been made. In this manner, for example, it is possible to carry out maintenance work in a specific region, such as a front region, of the exchange device module without subsequently carrying out a test run.

Particularly preferably, the exchange device itself is a standard robot that can also be used for other applications.

Preferably, the region in which an intervention can be detected is the region in which the magazine device is arranged. This makes it possible for user intervention in the magazine device to be detected. If no such user intervention has been detected, a test run can be dispensed with.

Preferably, the detection device can be a light barrier arrangement and, in particular, a light barrier curtain. In addition, it is also possible to detect the opening of a door of the enclosure.

The present invention is furthermore aimed at a method for operating an apparatus for forming plastic preforms into plastic containers, wherein, in a working operation of the apparatus, a transport device transports the plastic preforms to be formed along a predefined transport path, and wherein the transport device has a rotatable transport carrier, on which a large number of forming stations is arranged, wherein the forming stations each have blow molding devices, within which the plastic preforms are formed into the plastic containers by applying a flowable medium, and the forming stations each have application devices that apply the flowable medium to the plastic preforms. Furthermore, the apparatus has a clean room within which the plastic preforms are expanded to form the plastic containers, and such room is or will be delimited from a non-sterile environment by at least one wall.

In an exchange operation, an exchange device particularly preferably exchanges blow molding devices. In particular, such exchange device is an exchange robot. Preferably, such exchange device is arranged outside the clean room.

In a preferred method, the exchange device carries out a test run at least intermittently to check an occupancy state of a magazine device. In particular, there is a check of which and/or, if applicable, how many blow molding devices are located in the magazine device. In addition, a position of the blow molding devices in the magazine device is also preferably determined.

In addition, it is also possible for an exchange device to exchange a large number of blow molding devices and particularly preferably all blow molding devices of all forming stations in one exchange operation. In addition, it would also be possible for only parts of blow molding devices to be exchanged. Particularly preferably, the exchange device automatically exchanges such blow molding devices.

In addition, it is also possible that other elements of the blow molding devices or even other elements of the forming stations are changed. Particularly preferably, the rotatable transport carrier is rotated step by step or station by station in order to be able to exchange or to exchange further blow molding devices.

Particularly preferably, blow molding devices are removed from a magazine or a magazine device in order to be exchanged. Particularly preferably, blow molding devices are also inserted into the magazine device as part of the exchange process.

In a further preferred method, there is a check to determine whether a protective device in which the exchange device is located has been opened and/or there is a check to determine whether a user has entered a region in which a magazine device for storing the blow molding devices is located. Preferably, there is a check to determine whether a blow molding device has been exchanged by an user.

In a further preferred method, as a function of the check as to whether a protective device in which the exchange device is located has been opened and/or whether a user has entered a region in which a magazine device for storing the blow molding devices is located, a decision is made as to whether a test run is to be carried out.

If it is determined that no user has entered the region in a predefined period of time, then it can be decided that no test run will be carried out. If it is determined that a user has entered the region of the magazine device, a test run can be carried out.

### BRIEF DESCRIPTION OF THE DRAWINGS

Further advantages and embodiments result from the accompanying drawings. These show:

FIG. 1 a schematic illustration of an apparatus according to the invention;

FIG. 2 an illustration of the apparatus with an exchange device;

FIG. 3 a top view of the apparatus shown in FIG. 2;

FIG. 4 an illustration with an open interface;

FIG. 5 a further view with an open interface;

FIG. 6 an illustration of an actuating device of the apparatus;

FIG. 7 an illustration of the actuating device shown in FIG. 6;

FIG. 8 an illustration of a further actuating device; and

FIG. 9 an illustration for the exchange of application devices.

### DETAILED DESCRIPTION OF THE DRAWINGS

FIG. 1 shows an apparatus 1 for forming plastic preforms 10 into plastic containers 15. Such apparatus has a rotatable carrier 22 on which a large number of forming stations 4 is arranged. Such individual forming stations each have blow molds 82 that form a cavity inside them for expanding the plastic preforms.

Reference sign 84 denotes an application device, which is used to expand the plastic preforms 10. This can be a blow nozzle, for example, which can be applied to a mouth of the plastic preforms in order to expand the latter. Reference sign 90 denotes a valve arrangement, such as a valve block, which preferably has a large number of valves that control the application of different pressure levels to the plastic preforms.

In a preferred method, first a preblow pressure P1, subsequently at least one intermediate blow pressure Pi that is higher than the preblow pressure, and finally a final blow pressure P2 that is higher than the at least one intermediate blow pressure Pi are applied to the plastic preforms. After expansion of the plastic containers, the pressures or compressed air are preferably returned from the container to the individual pressure reservoirs.

Reference sign 88 denotes a stretching bar used to stretch the plastic preforms in their longitudinal direction. Preferably, all forming stations have such blow molds 82 along with stretching bars 88. Preferably, the number of such forming stations 4 is between 2 and 100, preferably between 4 and 60, more preferably between 6 and 40.

The plastic preforms 10 are fed to the apparatus via a first transport device 62, such as, in particular but not exclusively, a transport star. The plastic containers 15 are transported away via a second transport device 64.

Reference sign 7 denotes a pressure supply device, such as a compressor or also a compressed-air connection. The compressed air is conveyed via a connecting line 72 to a rotary distributor 74, which gives it via a further line 76 to the reservoir 2a, which in this case is an annular channel. Thus, preferably, such rotary distributor serves the purpose of feeding air from a stationary part of the apparatus into a rotating part of the apparatus.

In addition to such annular channel 2a shown, further annular channels are preferably provided, which are, however, concealed by, e.g., lie underneath, the annular channel 2a in the illustration shown in FIG. 1. Reference sign 98 denotes a connecting line that delivers the compressed air to a forming station 4 or the valve block 90 thereof. Preferably, each of the annular channels is connected to all forming stations via corresponding connecting lines. Such connecting line is preferably arranged in the rotating part of the apparatus.

Reference sign 8 schematically denotes a clean room, which is preferably annular here and surrounds the transport path of the plastic preforms 10. Preferably, a (geometric) axis of rotation with respect to which the transport carrier 22 is rotatable is arranged outside the clean room 8. Preferably, the clean room is sealed from the non-sterile environment by a sealing device, which preferably has at least two surge tanks.

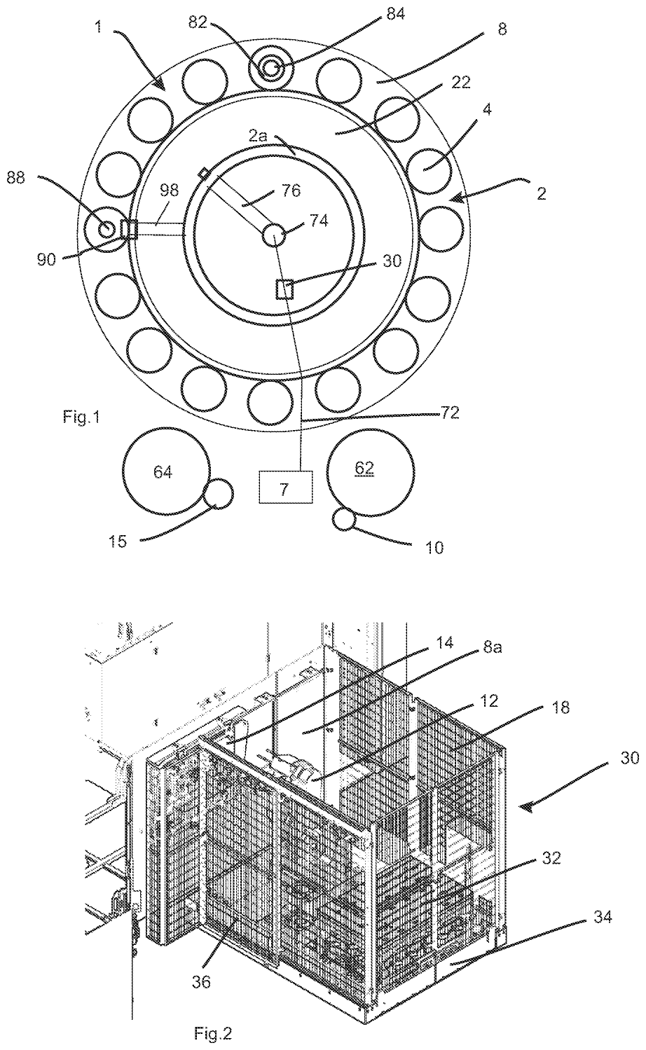

FIG. 2 shows a side view of an apparatus according to the invention. Reference sign 12 refers to an exchange device, in particular an exchange robot (however, the use of a manipulator would also be conceivable), which is used to exchange, for example, blow molding devices or the like. Reference sign 8a denotes a wall, which at the same time forms a boundary of the clean room. Reference sign 14 denotes an interface via which, for example, the exchange of blow molding devices can be carried out. Such interface is, in particular, a releasable opening through which the exchange device can exchange exchangeable parts, such as blow molding devices.

Reference sign 30 denotes in its entirety an enclosure, which in particular also serves to enclose the exchange device 12. This enclosure has a wall (possibly in the form of a grid) and also a door 36 that can be opened. Such enclosure serves in particular to protect the operating personnel but also, conversely, to protect the exchange device 12.

A magazine device 32, in which, for example, blow molding devices but also other exchange parts can be deposited, is preferably provided inside the enclosure. Reference sign 34 denotes a carrier on which the enclosure 30 and preferably also the magazine device 32 and the exchange device 12 are arranged.

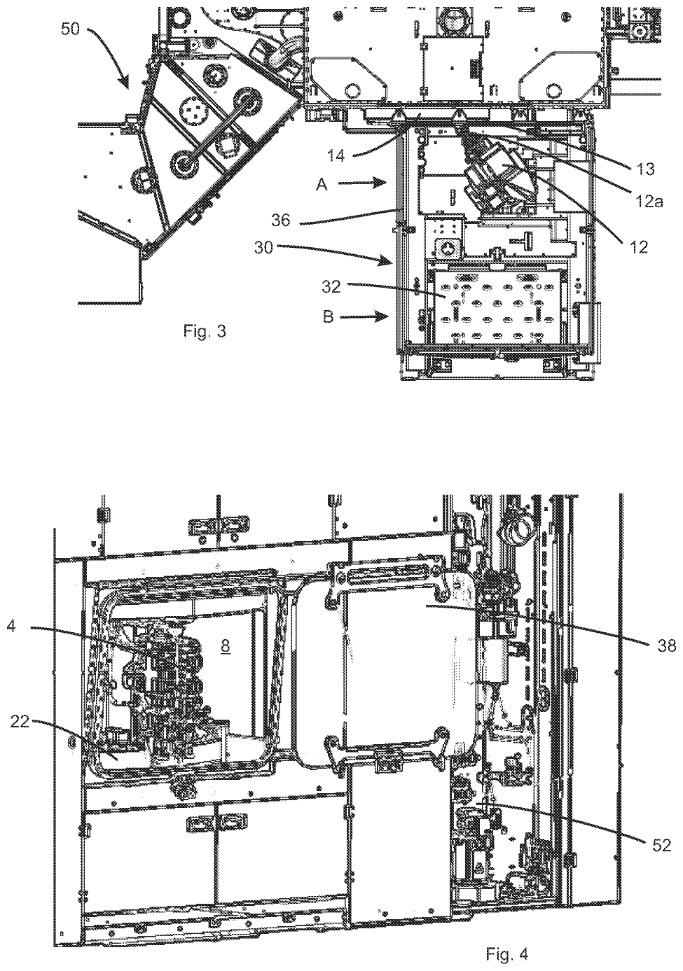

FIG. 3 shows a top view of the apparatus shown in FIG. 2. Here as well, the exchange device 12 and the magazine device 32 can be seen. The exchange device 12 can remove blow molding parts from the magazine device 32 and exchange them. Reference sign 14 in turn denotes the interface via which exchanges of blow molded parts, for example, are possible. Reference sign 12a denotes a gripping device of the exchange device. This gripping device 12a can be suitable and intended for gripping blow molding devices, for example.

Preferably, such gripping device is designed to be exchangeable and can, for example, be exchanged for other gripping devices (for example, for gripping application devices, such as blow nozzles).

When carrying out an exchange process, the interface 14 is initially opened, which can take place, for example, by opening an isolator window. This opening can take place manually, automatically or by the changeover device 12. This is followed by an exchange of exchangeable parts, such as the blow molding devices. In a further method step, the isolator window is closed again and the clean room is thus also closed. Finally, sterilization of the interior of the isolator or clean room preferably takes place.

Preferably, the apparatus described herein is capable of being operated in a working operation, or production operation, and in an exchange operation. Preferably, such operating modes are mutually exclusive and/or cannot be carried out simultaneously.

As shown in FIGS. 2 and 3, the exchange device 12, or the robot, is located outside the clean room, or not in the aseptic region. In this manner, it is possible that the exchange device 12 itself does not have to be sterile.

Reference sign 50 in FIG. 3 refers to a sterilization device, which is used to sterilize the plastic preforms.

In a preferred design, whether or not the door 36 of the enclosure 30 has been opened can be recognized. If the door has not been opened, it is possible that the exchange device will not carry out a further test run, since it has been ensured that no exchangeable parts have been removed from the enclosure by the user, for example. Such design is possible for the aseptic forming device described here and for non-aseptic applications. In this manner, it would also be preferably possible for maintenance work to be carried out in the front region A (see FIG. 3), for example, but not in the region of the magazine device B. In this case as well, it can be specified that no further test run of the robot device or exchange device 12 is carried out.

Between the region A and the region B, a detection device can be provided, such as a large number of light barriers and/or a light barrier curtain (not shown), by means of which it is possible to check whether a user has passed from the region A into the region B.

FIG. 4 shows a further illustration of the apparatus according to the invention. A door, or sliding door 38, is shown here. Next to it, the forming station 4, which is arranged within the clean room 8, can be seen. In addition, the station carrier 22, or the transport carrier 22, can also be seen. Reference sign 52 denotes a valve arrangement, or valve terminal, which is used to control pressures. This can preferably be arranged below the individual forming stations.

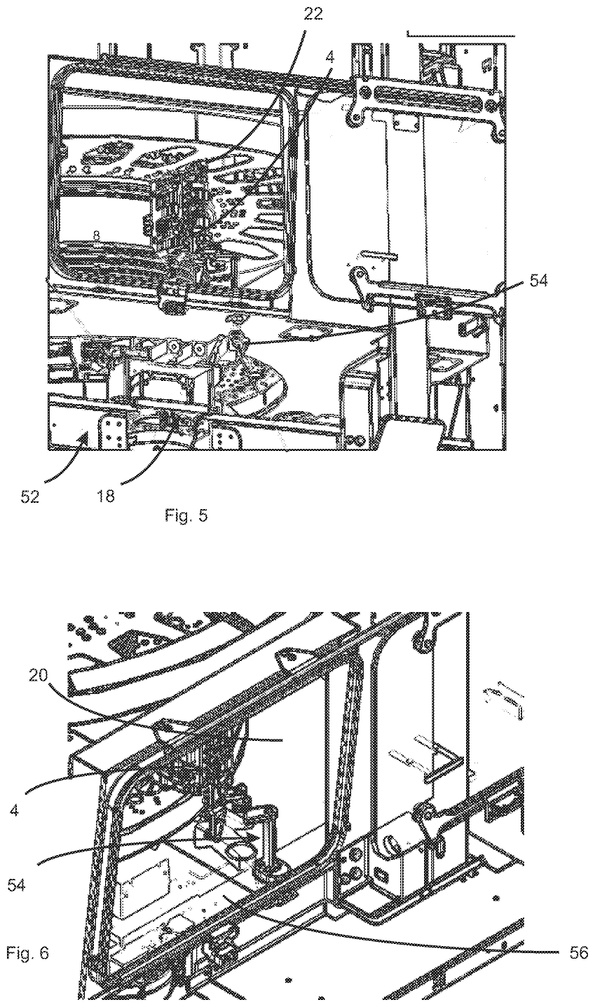

FIG. 5 shows a further view of an apparatus according to the invention. The actuating unit 54 for locking the mold carriers can also be seen here. It is preferably arranged partially outside the clean room and partially inside the clean room. Reference sign 18 refers to a centering unit along with the mold carrier actuator.

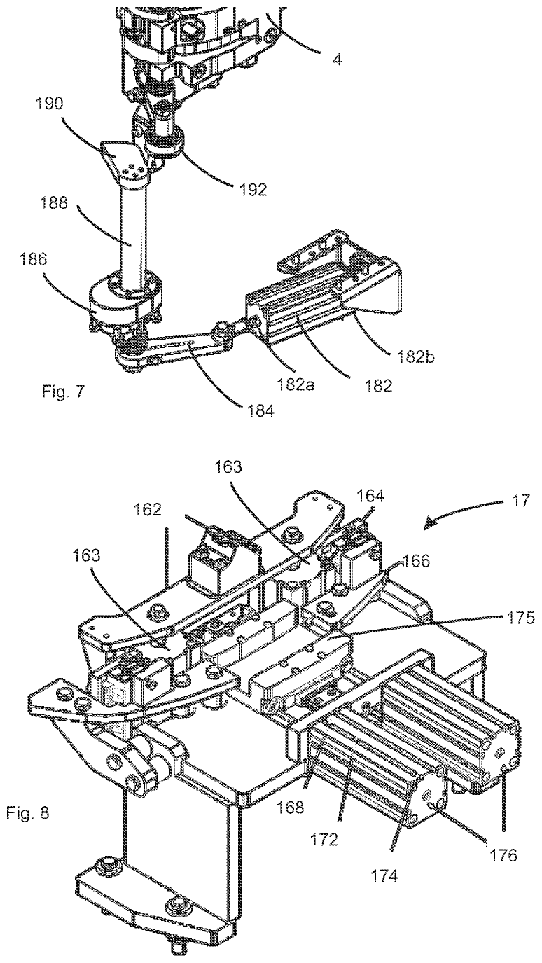

With reference to FIGS. 6 and 7, the actuating device 54 for locking the mold carriers is explained.

Particularly preferably, the actuating device 18 for locking (in particular a locking mechanism of the blow mold carriers) is arranged directly on a base plate 56 of the clean room. As can be seen from FIG. 7, such actuating device 18 has a double-acting cylinder device that is intended to open and close the locking flap of the mold carrier, in particular by means of a lever arrangement 184.

In particular, the double cylinder arrangement 182 is a pneumatic cylinder. Reference signs 182a and 182b indicate query positions for the cylinder device. In the position 182a, the cylinder device is retracted, and in the position 182b, the cylinder device is extended. Preferably, the apparatus therefore comprises a position determining device that detects a position of the cylinder device 182.

Reference sign 186 denotes a transmission element and reference sign 188 denotes a transmission rod via which rotational movements can be transmitted to a lever element 190. In this manner, the cylinder device can open or close a lock on the blow molding parts. Reference sign 192 denotes a cam follower that rolls relative to a guide cam (not shown) during working operation, in order to guide the blow mold carriers into a locked or unlocked state.

For the purpose of exchanging the blow mold, such locking mechanism can be actuated by the actuating device 18.

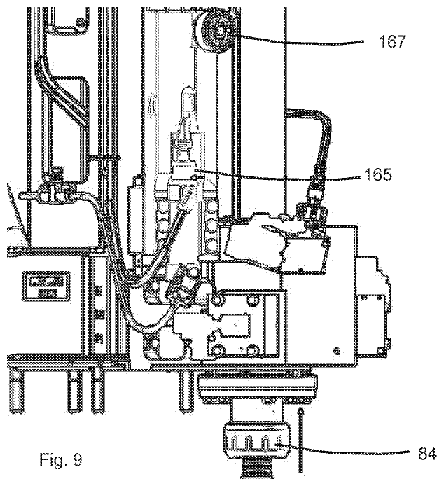

FIG. 8 shows a further actuating device 17 for opening and closing for the blow mold carriers and preferably also for centering. Preferably, a mold carrier actuator 176 is provided, along with a centering part 162 that is used to center the forming stations. Preferably, such actuating device 17 is also mounted on a base frame of the apparatus. Preferably, the actuating device 17 is arranged in such a manner that it can be subsequently mounted or dismounted, in particular without removing a forming station.

Preferably, the actuating device 17 has a rest position when a mold carrier cam is extended. In this manner, it is ensured that no collisions occur with a running machine or a machine in working operation.

As mentioned, reference signs 176 refer to pneumatic cylinders for controlling the centering block 175. Reference signs 163 refer to control cylinders for the mold carriers.

In the position shown with reference sign 166, the pneumatic cylinder for the centering block is retracted, and in the situation shown with reference sign 164, the cylinder for the centering block is extended.

In the situation marked with reference sign 174, the cylinder for the mold carrier is retracted, and in the situation marked with reference sign 168, the cylinder for the mold carrier is fully extended and thus in a rest position. In the position marked with reference sign 172, the cylinder is extended such that a mold exchange is possible.

Finally, FIG. 9 shows the actuating device for the blow nozzle 82 or, in a preferred design, a pneumatic spring, in particular in the form of a pneumatic cylinder 165, is used instead of a mechanical spring. Such pneumatic cylinder can actively actuate and/or advance the blow nozzle 82. The pneumatic cylinder is used in particular to clamp the blow nozzle in the direction of the plastic preform so that the blow nozzle does not lift off. Furthermore, a query device that detects a position of the roller 167 can be provided. For example, a central query of such roller position can be used by a proximity initiator, for example.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. An apparatus for forming plastic preforms into plastic containers, having a transport device, configured to transport the plastic preforms to be formed along a predefined transport path, wherein the transport device has a rotatable transport carrier on which a large number of forming stations are arranged, wherein such forming stations each have blow molding devices, within which the plastic preforms can be formed into the plastic containers by applying a flowable medium, and the forming stations each have application devices for applying the flowable medium to the plastic preforms, wherein the apparatus has a clean room within which the plastic preforms are expanded to form the plastic containers, and such clean room is delimited from a non-sterile environment by at least one wall,
wherein
the apparatus has an exchange device configured for exchanging blow molding devices and such exchange device is arranged outside the clean room.

2. The apparatus according to claim 1,
wherein
the apparatus has at least one actuating device configured for carrying out a exchange process of blow molding devices of the forming station and such actuating device is selected from a group of actuating devices comprising actuating devices configured for opening and closing blow mold carriers, actuating devices configured for releasing and activating a fastening device for releasing and fastening blow molding parts to blow mold carrier parts, actuating devices configured for centering the rotatable transport carrier, actuating devices configured for unlocking and locking blow mold carriers, actuating devices configured for tensioning and relaxing application devices, and actuating devices configured for opening and/or closing the clean room.

3. The apparatus according to claim 2,
wherein
at least one of the actuating devices is arranged outside the clean room.

4. The apparatus according to claim 1,
wherein
the apparatus has a magazine device configured for storing blow molding devices.

5. The apparatus according to claim 1,
wherein
the apparatus has an enclosure configured for enclosing the exchange device and such enclosure is divided into at least two regions.

6. The apparatus according to claim 5,
wherein
the two regions are separated from one another.

7. The apparatus according to claim 5,
wherein
the exchange device is arranged in one region and a magazine device configured for storing exchangeable parts is arranged in the other region.

8. The apparatus according to claim 1,
wherein
the apparatus has an openable interface, via which the exchange device can carry out exchange processes.

9. The apparatus according to claim 8,
wherein
the apparatus has an actuating device configured for opening the interface, wherein the interface can be opened manually or automatically or by the exchange device itself.

10. The apparatus according to claim 8,
wherein
the interface has a separating element configured to separate the clean room from the environment, wherein such separating element extends in a plane that is oblique with respect to a vertical direction.

11. The apparatus according to claim 1,
wherein
the apparatus has a detection device configured to detect an intervention of a user in predetermined regions of an enclosure for enclosing the exchange device, and a control device, which controls the exchange device taking into account a value detected by such detection device, is provided.

12. A method for operating an apparatus for forming plastic preforms into plastic containers, wherein, in a working operation of the apparatus, a transport device transports the plastic preforms to be formed along a predefined transport path, wherein the transport device has a rotatable transport carrier, on which a large number of forming stations is arranged, wherein such forming stations each have blow molding devices, within which the plastic preforms are formed into the plastic containers by applying a flowable medium, and the forming stations each have application devices that apply the flowable medium to the plastic preforms, wherein the apparatus has a clean room within which the plastic preforms are expanded to form the plastic containers, and such clean room is delimited from a non-sterile environment by means of at least one wall,
wherein
an exchange device exchanges and/or replaces blow molding devices in an exchange operation, wherein the exchange device is arranged outside the clean room.

13. The method according to claim 12,
wherein
the exchange device carries out a test run to check the occupancy state of a magazine device.

14. The method according to claim 12,
further comprising
carrying out a check as to whether a protective device in which the exchange device is located has been opened and/or carrying out a check as to whether a user has entered a region in which a magazine device for storing the blow molding devices is located.

15. The method according to claim 14,
further comprising
as a function of the check as to whether a protective device in which the exchange device is located has been opened and/or whether a user has entered a region in which a magazine device for storing the blow molding devices is located, a decision is made as to whether a test run is to be carried out.
